(19) United States
(12) Patent Application Publication
(10) Pub. No.: US 2005/0145647 A1
(43) Pub. Date: Jul. 7, 2005

(54) Self-defence module and use thereof

(76) Inventors: Jochen Neutz, Karlsruhe (DE); Klaus-Dieter Thiel, Karlsruhe (DE); Franz Weller, Aalen-Waldhausen (DE); Wilhelm Eckl, Karlsruhe (DE); Norbert Eisenreich, Pfinztal (DE); Hans Ebeling, Karlsruhe (DE)

Correspondence Address: LICHTI LEMPERT & LASCH, BERGWALDSTR. 1, D- 76227, KARLSRUHE, DE

(21) Appl. No.: 10/502,573

(22) PCT Filed: Jan. 21, 2003
(86) PCT No.: PCT/EP03/00526

(30) Foreign Application Priority Data
Feb. 2, 2002 (DE) 102 04 266.7

(51) Int. Cl. B67D 5/00

(52) U.S. Cl. 222/3; 222/129; 222/175; 340/574

(57) ABSTRACT

The invention relates to a self-defence module comprising a housing containing a chamber that holds a free-flowing active medium and comprising a compressed gas source for spontaneously dispensing the active medium from the chamber. In order to be able to miniaturise the self-defence module, the compressed gas source is configured from a pyrotechnic gas generator and an ignition unit that interacts with the generator. According to the application, the ignition unit can be triggered manually or by a sensor. The invention also relates to the use of a self-defence module of this type for the protection of persons, buildings, means of transport or valuables.

The invention concerns a self-defence module comprising a housing with at least one chamber for receiving a flowable active medium, and a pressure gas source for spontaneous discharge of the active medium from the chamber. The invention also concerns the use of such a self-defence module.

In conventional self-defence modules of this type, the active medium serves either to temporarily impede action of a potential attacker or thief without injuring him/her, or at least fend off and/or mark such a person to be able to uniquely identify and thereby capture him/her. The active media which can be used for this purpose are e.g. fine-particle pepper dispersions, bad smelling or irritating gas mixtures, coloring fluids etc.

Self-defence modules with a manual trigger of the above-mentioned type for the protection of persons are realized nearly exclusively in the form of “sprays”, wherein the active medium is contained in a pressure container and can be released using propellants. The large dimensions of the self-defence modules, which are required for the volume of the propellant, disadvantageously make them difficult or even impossible to conveniently carry in clothes, bags or the like in a space-saving and unnoticeable manner. Moreover, the pressure containers can fail due to thermal influences, e.g. exposure to sunshine and resulting overpressure, thereby representing a health risk to the user and his/her surroundings. This is, in particular, the case for combustible propellants such as hydrocarbons, which are moreover ecologically harmful. In addition, the active medium cannot be released from the pressure container in a precise manner, since the flow does not depend linearly on the pressure of the propellant.

Sensor-triggered self-defence modules for protecting goods have the additional disadvantage that the pressure containers which hold the active medium must be checked and serviced at regular intervals to meet the safety requirements for such pressure vessels.

It is the underlying purpose of the invention to propose a simple and inexpensive self-defence module which eliminates the above-mentioned disadvantages and permits, in particular, miniaturization of the dimensions and weight thereof.

This object is achieved in accordance with the invention with a self-defence module of the above-mentioned type in that the pressure gas source is formed by a pyrotechnical gas generator and an ignition unit which is effectively connected thereto.

The inventive design avoids the use of pressure containers for discharge of the active medium. This considerably reduces the costs and also permits miniaturization of the module compared to the propellant volume previously required for conventional self-defence modules, since the preferably solid and compact pyrotechnical gas generator charges require considerably less space. The inventive self-defence module provides safe and reliable operation over a wide temperature range, thereby preventing untimely triggering or even explosions due to overpressure under thermal influence. The flow behavior of the active medium when the ignition unit is triggered develops under reproducible conditions which are fixed by the type, amount and arrangement of the pyrotechnical charge of the gas generator to permit accurate discharge of the active medium. The desired spray shape and range can be precisely defined in dependence on the geometry of the outlet opening(s) of the chamber through which the active medium is discharged. The outlet opening of the chamber can be closed e.g. through an overpressure valve, a bursting diaphragm or corresponding means.

Suitable pyrotechnical charges for the gas generator are preferably propellant and explosive mixtures which are harmless to health and environment, wherein principally mixtures containing or releasing nitrogen, e.g. on the basis of nitro-1,2,4-triazole-5-on (NTO), nitro guanidine (NIGU) etc. in connection with suitable oxidants have proven to be advantageous.

In a preferred embodiment, the gas generator is separated from the active medium through a piston which can be displaced along the cross-section of the chamber holding the active medium. When the pyrotechnical gas generator is triggered, the piston is displaced by the generated gas pressure in the chamber having the active medium, causing the active medium to be displaced and released via one or more outlet openings which are disposed on the side of the chamber facing away from the piston.

In accordance with another preferred embodiment, the gas generator is separated from the chamber holding the active medium via a bursting diaphragm, wherein the gas volume generated by the gas generator suddenly flows into the chamber holding the active medium and is released together therewith.

The ignition unit may e.g. be activated electrically, wherein the current may be supplied through a supply voltage or current storage such as a battery, a storage battery or the like, in dependence on the application for the self-defence module. The ignition unit of a stationary self-defence module, e.g. to protect buildings, is advantageously fed by a supply voltage. The ignition unit of a self-defence module to protect transport means or of a portable self-defence module to protect persons is suitably powered by batteries or storage batteries.

An electric storage unit may be provided in an electrically triggered ignition unit to store part of the energy released when the pyrotechnical gas generator is triggered, thereby storing energy which is normally not completely utilized when releasing the active medium. The energy is thereby stored in the form of electric energy to facilitate multiple use of the self-defence module. The storage unit may be e.g. a storage battery or a capacitor and a micro turbine is preferably used to convert the gas energy released upon triggering the gas generator into electric energy and may be disposed e.g. in the region of the outlet opening or in the region of a cross-section of the housing of the self-defence module through which the gas flows.

The ignition unit may e.g. alternatively be formed by a mechanical firing pin unit, wherein a spring-loaded firing pin ignites the pyrotechnical charge of the gas generator in a purely mechanical manner.

For a portable self-defence module, in particular, for the protection of persons, the ignition unit can suitably be manually triggered which may occur e.g. through a button which is connected to the electric or mechanical ignition unit.

In the case of a stationary self-defence module, in particular to protect goods, the ignition unit may alternatively be triggered by a sensor, wherein any conventional sensors, such as light barriers, motion detectors, heat or sound sensors, pressure sensors or the like may be used.

In a preferred embodiment, the pyrotechnical charge of the gas generator or the entire gas generator is preferably designed as an exchangeable unit to ensure multiple use of the self-defence module. The active medium is preferably also exchangeable, wherein e.g. active medium reservoirs are provided in the form of cartridges or magazines which can be inserted into the housing of the self-defence module and/or with which the chamber receiving the active medium can be filled.

The flowable active media may be any conventional substances, such as irritating or odorous substances in a fluid or dispersive form, colorants which are difficult to remove or the like depending on the intended use of the self-defence module. Barbiturates may also be used as active media to protect e.g. public buildings or banks from criminal acts such as kidnappings, blackmailings, robberies or the like or render potential attackers temporarily inactive. Adsorptive and/or absorptive substances, e.g. activated carbon dust dispersions are also feasible to ensure effective protection of persons in case of terrorist attacks with chemical weapons on buildings or transport means such as airplanes, trains or buses. Alternatively or additionally, substances may be used as active media for the same purpose which are suited to neutralize chemical weapons. Finally, antibiotic substances or disinfectants, e.g. tensides, titanium dioxide dispersions or any other conventional correspondingly active substances may also be used to protect the relevant persons in case of terrorist attacks, in particular using biological weapons.

As mentioned above, the inventive self-defence module is suited as portable self-defence module, e.g. for installation in particularly small sized articles, such as writing instruments, mobile telephones, flash lights, key rings or the like due to its small size, wherein it serves mainly for protection against a potential attacker or thief to render him/her temporarily inactive or at least fend him/her off without impairing his/her health.

The self-defence module is also suitable for burglar protection or as supplemental equipment for burglar protection together with another active mechanism for stationary installation in buildings, safety cabinets, safes, and the like, wherein it provides active self-protection against burglars and thieves, in particular, in connection with a sensor-triggered ignition unit.

The inventive self-defence module is also suited for theft protection for mobile objects or as supplemental equipment for theft protection together with another active mechanism, e.g. for installation in automotive vehicles and motorbikes, sports devices such as boats, surfboards, skis, snowboards, bikes and the like or electronic devices such as TV sets, stereos, video recorders, cameras, car radios etc. to also protect them against unauthorized access. The invention is thereby based on the statistically proven findings that many stationary safety systems can be easily rendered ineffective by an unauthorized person if the trigger mechanism, energy supply etc. is known, without providing effective protection from such unauthorized manipulation. Many optical and acoustical warning systems also often fail to deter since they are no longer taken seriously due to their commonness and the fact that they are often subject to malfunction, and also since the unauthorized manipulator is not directly personally impaired. With an installed inventive self-defence module, the manipulator is directly rendered inactive or is marked.

The self-defence module is also suited to protect buildings and/or transport means, such as airplanes, trains, buses or the like from criminal or terrorist attacks, wherein it either renders the attackers temporarily inactive using sleep-inducing agents or at least impairs the action of released chemical and/or biological weapons.

The invention is described below on the basis of embodiments with reference to the drawing.

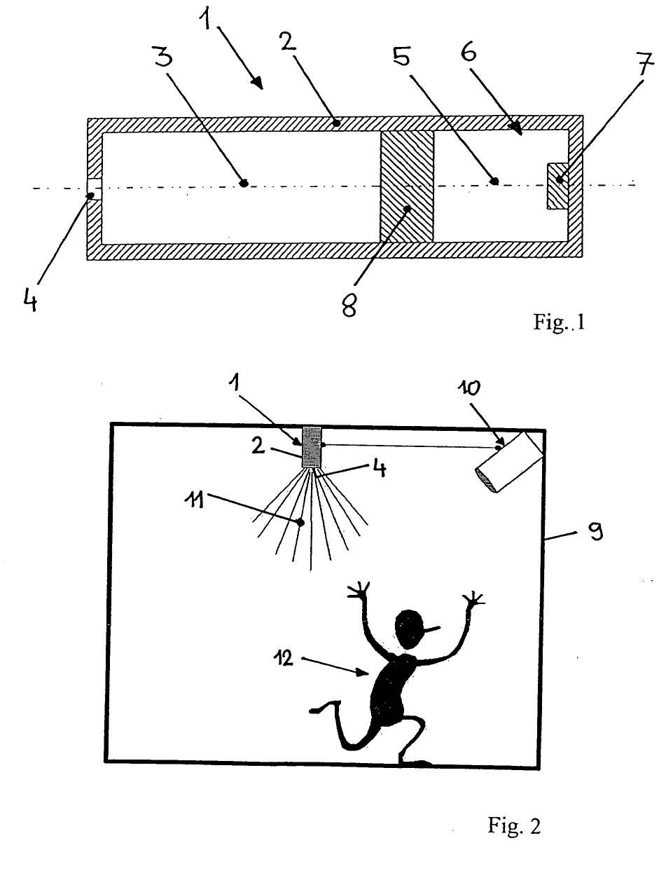

FIG. 1 shows a schematic sectional view of an embodiment of an inventive self-defence module; and

FIG. 2 shows an embodiment variant of the self-defence module in accordance with FIG. 1 as a stationary module to protect buildings or transport means.

The self-defence module 1 shown in FIG. 1 comprises a substantially tubular housing 2 with a chamber 3 receiving a flowable active medium, which is provided with an end-side outlet opening 4 which is closed e.g. by a pressure control valve (not shown). A pyrotechnical charge 5 of a gas generator 6 which borders the side of the chamber facing away from the outlet opening 4 is provided as a pressure gas source to discharge the active medium from the chamber 3 and is actively connected to an ignition unit 7 which e.g. can be electrically activated. The pyrotechnical charge 5 of the gas generator 6 of the present embodiment is separated from the active medium contained in the chamber 4 via a piston 8 which can be displaced along the cross-section of the chamber 3 of the housing 2 holding the active medium, wherein the piston 8 is displaced in the direction of the outlet opening 4 upon ignition of the pyrotechnical charge 5 of the gas generator 6 due to the generated gas pressure, thereby spontaneously releasing the active medium via the outlet opening 4.

In a portable self-defence module 1 to protect persons, the ignition unit 7 can suitably be manually triggered and is supplied with current through storage batteries or batteries e.g. round cells (not shown). The self-defence module 1, which is small compared to conventional self-defence modules in the form of pressure gas containers, may be integrated in this case in any item of every day use, such as writing instruments, mobile telephones, flash lights, key rings or the like (not shown).

FIG. 2 shows the self-defence module 1 in accordance with FIG. 1 as a stationary module which is provided e.g. in a housing 9, public transport means or the like to protect against unauthorized access and/or criminal or terrorist attacks. The ignition unit (not shown) of the self-defence module 1 is connected to a sensor 10, e.g. a light barrier, a heat sensor etc. to cause automatic triggering.

As soon as a person 12 has gained unauthorized access into the protected housing 9, the ignition unit of the self-defence module 1 is triggered through sensors and the active medium 11 is released in a precise manner through the outlet opening 4 of the module 1. The active medium 11 may e.g. be irritating substances or barbiturates to render the person 12 temporarily inactive without injuring him/her. Colorants which are difficult to remove may also be used to mark that person and provide the public authorities with a unique identification characteristic. For protection from criminal or terrorist attacks, absorbents or adsorbents, substances which neutralize chemical weapons or antibiotically active substances and disinfectants may also be used to weaken at least the efficiency of willfully released harmful substances and largely prevent or curtail injuries to third persons.

1-27. (canceled)

28. A self-defence module comprising:
a housing having at least one chamber for receiving a flowable active medium;
a pyrotechnical gas generator; and
an ignition unit in active communication with said pyrotechnical gas generator, wherein said pyrotechnical gas generator and said ignition unit cooperate to constitute a pressure gas source for discharge of the active medium from said chamber.

29. The self-defence module of claim 28, wherein said gas generator is separated from the active medium by a piston which can be displaced along a cross-section of said chamber to discharge the active medium.

30. The self-defence module of claim 28, wherein said gas generator is separated from the active medium via a bursting diaphragm.

31. The self-defence module of claim 28, wherein said ignition unit is structured and dimensioned for electrical activation thereof.

32. The self-defence module of claim 31, wherein said ignition unit is supplied with current via a supply voltage.

33. The self-defence module of claim 31, wherein said ignition unit is supplied with current via at least one of a current storage means, a battery or a storage battery.

34. The self-defence module of claim 31, further comprising an electric storage unit for storing an energy portion released through triggering of said gas generator, said energy portion being stored as electric energy in said electric storage unit.

35. The self-defence module of claim 34, wherein said electric storage unit comprises at least one of a storage battery or a capacitor.

36. The self-defence module of claim 34, wherein said electric storage unit comprises a micro turbine for converting energy released through triggering said gas generator into electric energy.

37. The self-defence module of claim 28, wherein said ignition unit comprises a mechanical firing pin member.

38. The self-defence module of claim 28, wherein said ignition unit is structured and dimensioned for manual triggering.

39. The self-defence module of claim 28, wherein said ignition unit is structured and dimensioned for triggering via sensors.

40. The self-defence module of claim 28, wherein said gas generator is structured and dimensioned as an exchangeable unit.

41. The self-defence module of claim 28, wherein said pyrotechnical charge of said gas generator is structured and dimensioned as an exchangeable unit.

42. The self-defence module of claim 28, wherein the module is structured for exchange of the active medium.

43. The self-defence module of claim 28, wherein the active medium comprises irritating substances.

44. The self-defence module of claim 28, wherein the active medium comprises colorants.

45. The self-defence module of claim 28, wherein the active medium comprises barbiturates.

46. The self-defence module of claim 28, wherein the active medium comprises adsorptive and/or absorptive substances.

47. The self-defence module of claim 28, wherein the active medium comprises substances which neutralize chemical weapons.

48. The self-defence module of claim 28, wherein the active medium comprises antibiotic substances.

49. The self-defence module of claim 28, wherein the active medium comprises disinfectants.

50. Use of the self-defence module of claim 28 as burglar protection or as supplemental equipment for burglar protection together with a different active mechanism.

51. Use of the self-defence module of claim 28 as theft protection for mobile articles or as supplemental equipment for theft protection together with a different active mechanism.

52. Use of the self-defence module of claim 28 as a portable self-defence module.

53. Use of the self-defence module of claim 52 as an installation part in portable items of every day use.

54. Use of the self-defence module of claim 28, for protection of buildings and/or transport means from criminal or terrorist attacks.
